(19) United States
(12) Patent Application Publication
(10) Pub. No.: US 2017/0333755 A1
(43) Pub. Date: Nov. 23, 2017

(54) MULTI-SPORT BIOMETRIC FEEDBACK DEVICE, SYSTEM, AND METHOD FOR ADAPTIVE COACHING WITH GYM APPARATUS

(71) Applicant: Kuaiwear Limited, Kowloon (HK)

(72) Inventor: Carlos Marco Rider, Kowloon (HK)

(21) Appl. No.: 15/597,731

(22) Filed: May 17, 2017

Related U.S. Application Data
(60) Provisional application No. 62/337,538, filed on May 17, 2016.
(60) Provisional application No. 62/354,490, filed on Jun. 24, 2016.

(51) Int. Cl. A63B 24/00; A63B 71/06; A63B 21/06; H04R 1/10

(52) U.S. Cl. CPC A63B 24/0075; H04R 1/105; A63B 24/0062; A63B 71/0622; H04R 1/1016; H04R 1/1041; A63B 21/06; A63B 2225/50; A63B 2220/62; A63B 2220/30; A63B 2220/20; H04R 2420/07; A63B 2230/75; A63B 2024/0068; A63B 2071/0625; A63B 2220/12; A63B 2230/06

(57) ABSTRACT

A system and method provides real-time coaching and adjustment to training. A wearable device may be configured for over-the-ear wear, which includes a speaker, a transceiver, and sensors to measure biometric activity in the user while worn during athletic performance training. The system uses a method which compares past performance to current performance and training goals to adjust a training plan during performance for maximizing training results. The system analyzes current and past performance and generates new training performance output goals in real-time based on the user's current performance. The system then transmits coaching output during a live training session instructing the user on how to adjust their performance output during a current training session. Some embodiments include connecting to smart gym apparatus which connect to the system and automatically increase/decrease resistance/speed depending on the system determining a need to change performance output for maximum gains.

### CROSS-REFERENCE TO RELATED APPLICATION

This application claims benefit under 35 U.S.C. §119(e) of U.S. Provisional Application Ser. No. 62/337,538 filed May 17, 2016 and Ser. No. 62/354,490 filed Jun. 24, 2016, which are hereby incorporated by reference herein in their entirety.

### FIELD

The subject disclosure relates to sporting goods, and more particularly, to a multi-sport biometric feedback device, systems, and method for adaptive coaching.

### BACKGROUND

Improvement and progression in athletic performance is traditionally done one-on-one between a coach and an athlete. Technology has augmented the training process by providing measurements of athletic performance which can be reviewed after the athlete is done with a training session. The results may be reviewed and the athlete typically merely checks to see whether they have met their goal.

Some technologies exist which provide information to the athlete while training. Typically the information is related to heart rate, time training and distance covered.

However, as may be appreciated, the current technology does not help improve performance during training. The athlete is primarily relying on static information after performance to make adjustments for the next training session.

As can be seen, there is a need for a system and method which provides feedback and adjustment to the training session during athletic performance so the athlete can improve while working out to maximize goals.

### SUMMARY

In one aspect of the disclosure, a system for improving sports performance comprises a remote computer server; data storage in the remote computer server storing a pre-defined set of training goals for a user and past recorded training data from past training sessions performed by the user; and an electronic gym apparatus. The electronic gym apparatus includes a resistance or speed based exercise function, a wireless transceiver, and a processor. The processor is configured to: detect an amount of exercise output performed by the user during a live training session using the gym apparatus, compare the amount of exercise output performed by the user during the live training session using the gym apparatus to goals in the pre-defined set of training goals and to the past recorded training data from past training sessions performed by the user, analyze the amount of exercise output performed by the user during the live training session using the gym apparatus and the past recorded training data from past training sessions performed by the user for changes in performance, and adjust the electronic gym apparatus to increase or decrease exercise resistance or speed based on detecting changes in performance by the user.

It is understood that other configurations of the subject technology will become readily apparent to those skilled in the art from the following detailed description, wherein various configurations of the subject technology are shown and described by way of illustration. As will be realized, the subject technology is capable of other and different configurations and its several details are capable of modification in various other respects, all without departing from the scope of the subject technology. Accordingly, the drawings and detailed description are to be regarded as illustrative in nature and not as restrictive.

### BRIEF DESCRIPTION OF THE DRAWINGS

FIG. 1A is a perspective right side view of a biometric feedback device in accordance with an aspect of the subject technology.

FIG. 1B is a perspective side view of the biometric feedback device of FIG. 1A.

FIG. 2 is a schematic illustrating the functionality provided by the biometric feedback device(s) of FIG. 1A integrated into a single device.

FIG. 3 an exploded view of the device of FIG. 1B.

FIGS. 4A, 4B, and 4C are a series of screenshots showing biometric feedback to a user on an app displayed by a general computing device in accordance with an aspect of the subject technology.

FIG. 5 is a flowchart of a method of providing real-time training and adaptive coaching using the device of FIG. 1A in accordance with an aspect of the subject technology.

FIG. 6 is a block diagram of a system for biometric feedback and adaption of gym equipment output according to an embodiment of the subject technology.

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, it will be apparent to those skilled in the art that the subject technology may be practiced without these specific details. Like or similar components are labeled with identical element numbers for ease of understanding.

In general, exemplary embodiments of the subject technology provide a system and method which provides real-time training adjustment to the user based on biometric feedback during a training session which maximizes training performance and results. Some embodiments include a wearable device which provides real-time coaching and adjustments to training regimens during a training session. Some embodiments include a system which connects to a gym apparatus and adjusts the output (for example resistance, speed of operation, etc.) of the apparatus to intensify or lessen a workout to maximize training (or in some cases moderate training back to a safe level).

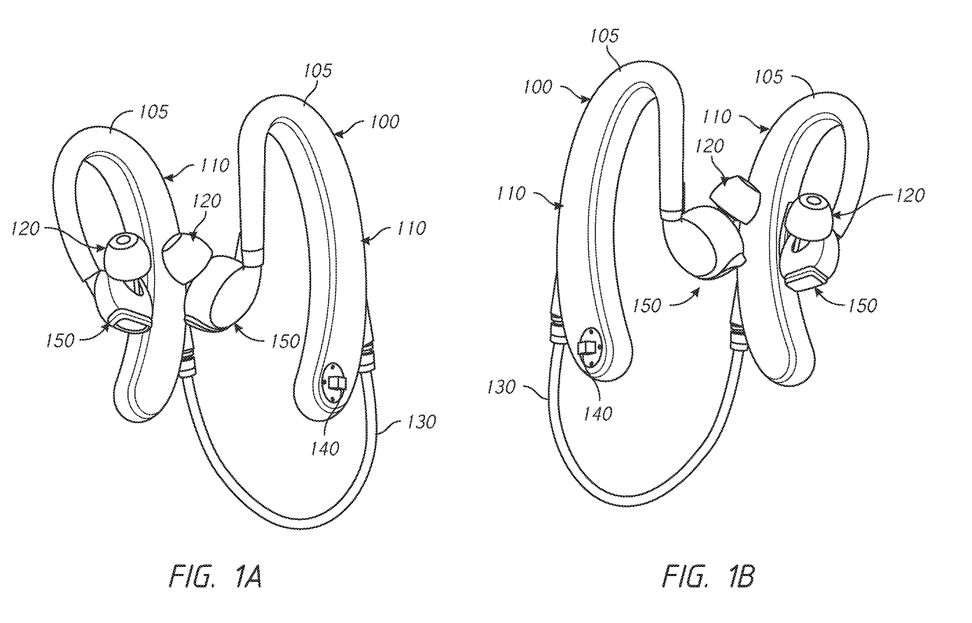

Referring to FIGS. 1A, 1B, and 2-3, a device 100 is shown according to an exemplary embodiment which is worn by the user during an athletic performance training session. The device may be an over-the-ear headset with sensors integrated therein for multi-sport training. The device records the wearer's biometric data and uses the user's personal profile, body vitals, performance metrics, personal settings and/or other parameters, to deploy adaptive files that could be either pre-recorded in a device or supplied by a secondary user in a way of cross communication by wireless protocols, using feedback methods such as voice, vibration, lighting, etc. during different physical activities.

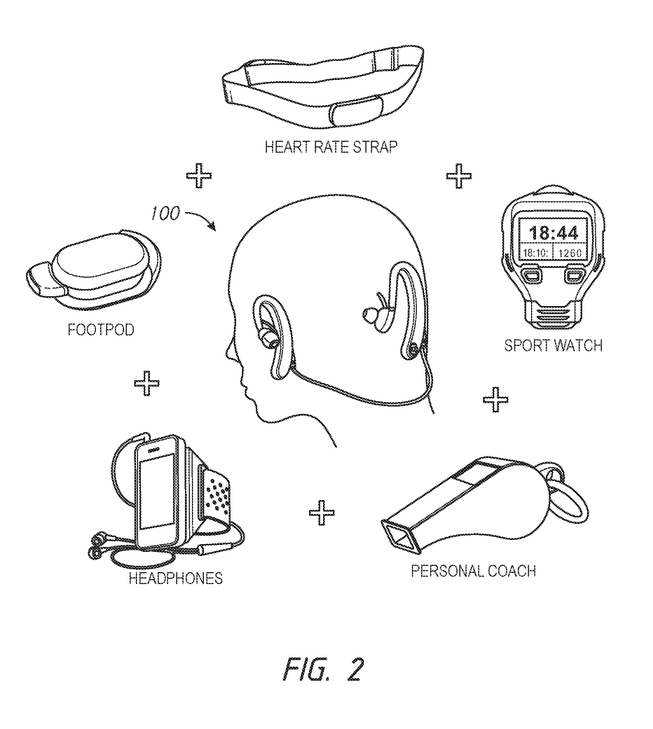

The device may be a self-contained coaching device, which may work entirely by itself to monitor biometrics, using the athlete's past and current performance statistics and recorded performance data from other athletes to actively adapt the file parameters to provide real-time feedback to a user. The device can be used during any sport performed on land, water or air. For example, some embodiments include waterproofing to prevent moisture from ambient water while swimming or the athlete's sweat from penetrating the circuitry contained internally. The device may operate completely independent using its integrated microchip, memory and integrated sensors, or it can also operate connected to other devices wirelessly, like for example phones, watches, tracking devices, bike sensors, powers meters, etc. Device functions (for example, those shown in FIG. 2) are accessible using menu systems and controls. As will be appreciated, embodiments integrate a host of functions including for example heart rate monitoring, accelerometer measurements, gyroscopic movement sensing, barometric measurements, timing measurements, along with auditory means to transmit real-time personalized coaching during a training session.

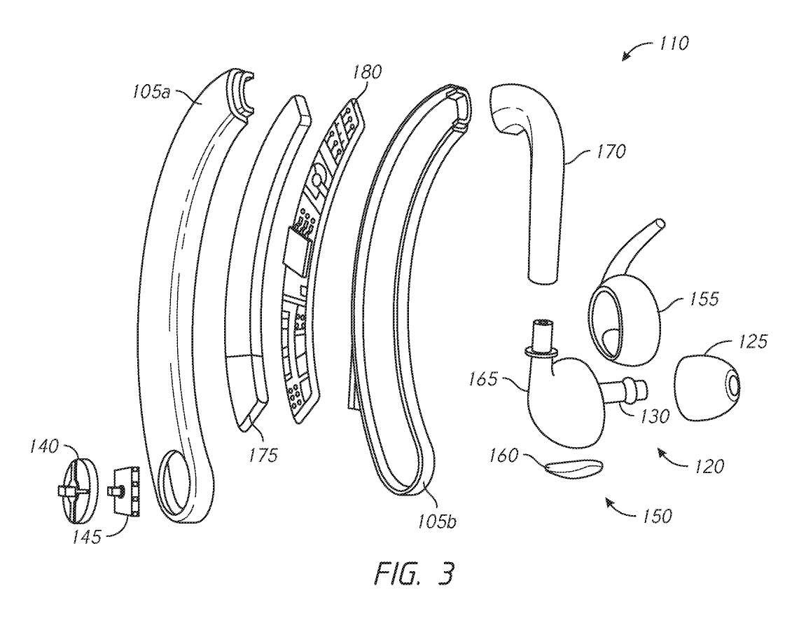

Referring in particular to FIGS. 1A, 1B and 3, the device 100 may include a right arm and/or left arm 110 configured to be worn on the ears. In some embodiments, the right and left arms 110 may be tethered together by a wire 130 which may communicate electrical signals between the two arms 110. Each arm 110 may comprise a shell 105 housing the various components shown. At one distal end of an arm 110, the device 100 may include a control switch 140 which the user may engage to access various functions within the device 100. For example, touching, rotating, or pressing the control switch 140 may activate a joystick 145 underneath the switch which can adjust volume, scroll through menus, and answer phone calls. In some embodiments, the shell 105 may comprise two shell halves 105a and 105b as shown in FIG. 3 for housing a control board 180 connected to the control switch 140 and one or more of the biometric sensors coupled to the device 100. The control board 180 may include for example a microprocessor, a transceiver, and other electronic components on a printed circuit board. On the opposite end of the arm 110, an earpiece module 150 may be configured for fitting into a user's ear. The earpiece module 150 may include earbuds 120. The earbuds 120 may include an ear tip 125 covering a speaker 130 and an acoustic mesh to prevent fluids entering the device. The speaker 130 may project from a back case 165 through an earbud gel cover 155. A wrap-around stem 170 projects downward from the top of a user's ear to connect the back case 165 (and earbud 120 components) to the shell halves 105.

In an exemplary embodiment, the device 100 may include a heart rate sensor 160 attached to for example the earpiece module 150 or to the speaker. The heart rate sensor 160 is disposed to pick up heart rate beats from a user's ears when the device 100 is worn. Other sensors integrated into the device 100 (for example on control board 180) include an accelerometer, GPS, altimeter, internal memory, audio playing capability for both training, coaching, playing music, and receiving phone calls, and other sensors to collect activity data. Some embodiments include a variety of ear tips for different activities including for example, waterproofing features for activity in wet conditions, or open design ear tips to hear the surroundings and improve safety. For sake of illustration, wiring between the ear bud 120, sensors, and the control board 180 is omitted. However, a power source 175 (for example a battery pack) is connectable to the control board 180 to power any of the electronic components described.

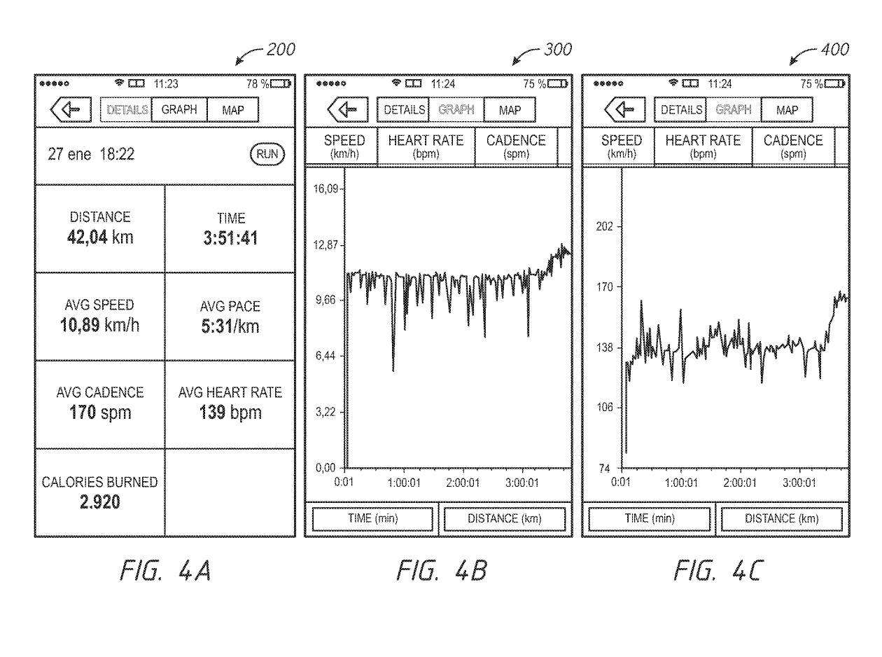

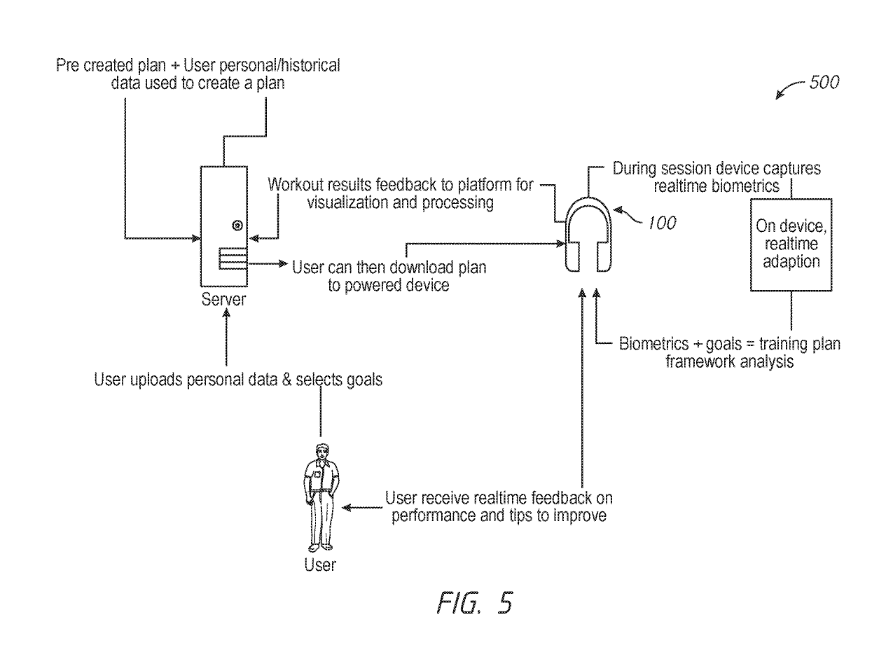

Referring now to FIGS. 4A, 4B, 4C, and 5, a system embodiment (FIG. 5) and screenshots of a user interface (FIGS. 4A, 4B, and 4C) are shown according to exemplary embodiments. In a system embodiment, the worn device 100 may communicate with a host server over a network. The host server may store computer program instructions for operation of the system in general. Also resident on the host server may be stored performance files for each user, pre-designed training plans, and coaching modules including pre-recorded voices. In an exemplary embodiment, the host server or the device itself may include memory storage containing program modules configured to analyze biometric feedback transmitted by the user's device during training. Some embodiments include providing a mobile app accessible by a smart phone, computing tablet, wearable computing device, portable or desktop computer or the like. As shown in FIGS. 4A, 4B, and 4C, results of training may be shown on an electronic user interface which may be accessed through an online portal. The portal may provide graphical views showing current or past performance output as registered by the biometric sensors on the worn device. For example, FIG. 4A shows a user interface 200 displaying data related to a current distance based activity as measured by the device 100. FIG. 4B shows a user interface 300 displaying the speed of a user during the training session as measured by the device 100. FIG. 4C shows a user interface displaying the user's heart rate during a training session as measured by the device 100. The data may be shown on the online platform for visualization, processing and analysis of how the latest performance matches the target goals and comparing the data against previous sessions. As discussed below, third parties such as human coaches may have access to the data. The online platform enhances the device, processes and customer experience, by which users can connect with other users and coaches in a social as well as professional manner and share the data, compete with others, participate in leaderboards, communicate, share programs, provide advice, motivate, etc. The analysis of performance output and method associated therewith to provide adaptive training during a training session is discussed below.

Referring now to FIG. 5, a method 500 for providing adaptive coaching to an athlete during a training session is shown according to an exemplary embodiment. In general, the host server or the device 100 (via one or more computer processors) control a backend interface that allows the user or an administrator to create, categorize, record, price and upload sport specific training programs to the server. Training programs may be performed while the user and device 100 are connected online (either within a LAN, WAN, mobile based or Internet based network or any combination thereof). The program creator may select training parameters, voice recording for real-time coaching feedback, and other data points, which can be edited and reviewed during and after completion of the program. The training programs may, in some embodiments be made available for other users to view, purchase and download to their device. The server-based element contains an interactive plan creation mechanism, using visual aids and an easy-to-use form by which users can create and edit their own training plans or select plans from coaches or the community. The plans may be “pre-defined” and form the goals to be achieved along with milestones and intervals the user wishes to base their session(s) on. Once the user deploys pre-defined plans to their device, the plans can be further adapted using the sum of all the data (goals, past experience, personal biometrics, and other users' performance statistics) to provide a comprehensive and targeted workout plan to be followed.

The sport specific training programs may be pre-recorded programs specifically designed to help achieve certain fitness goals. The programs instruct the user through a series of exercises during different sports/exercises, using a combination of different routines and interval sessions at different levels of difficulty, and changing, increasing, maintaining, and adapting the intensity of the exercises over a time until the user achieves a recorded fitness goal. For example, the user may choose a training program to achieve fitness goals like losing weight, running faster, riding further, swimming longer, getting fitter, increasing muscle volume, relaxing, etc. The coaching function may for example instruct the user to increase speed to maximum exertion for an interval of time and then decelerate for a period until increasing exertion again to improve certain sprint based activities. In another example, the coaching function may detect that a weight resistance program's performance has plateaued and may instruct the user to increase the weight for a next set of lifts for lesser repetitions to trigger increased strength performance.

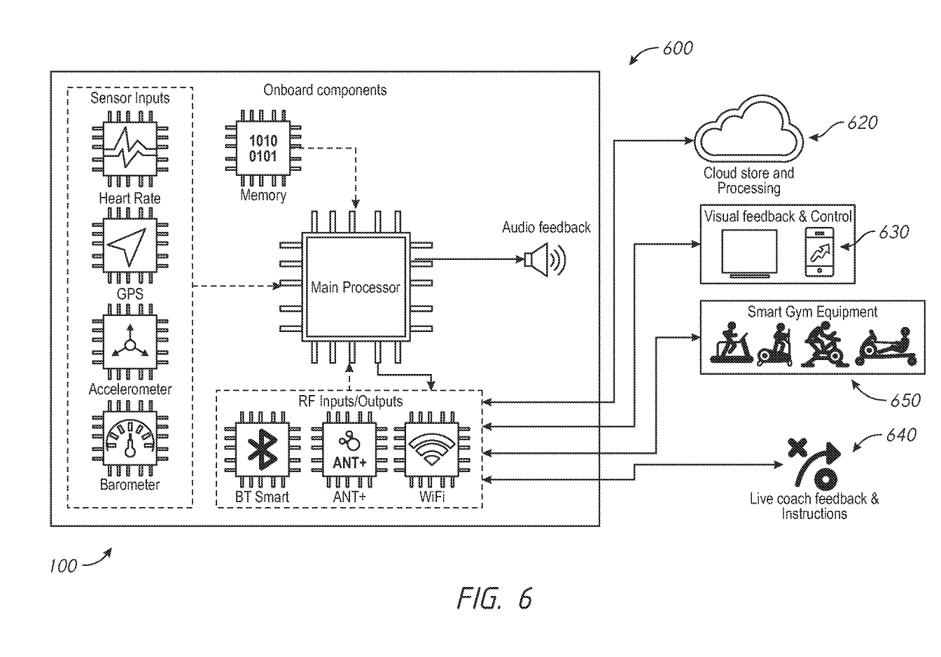

Referring now to FIG. 6, exemplary embodiments of the subject technology provide a system 600 which receives biometric feedback from a user exercising on gym apparatus 650 and adjusts the output of the gym apparatus 650 based on the biometric feedback. The gym apparatus 650 (sometimes referred to in the singular or plural as gym equipment 650) includes its own wireless transceiver and processing unit or controller configured to control the output parameters for exercise.

In some embodiments, the biometric data is provided by the gym apparatus 650 equipped with sensors and transmitted to an external user device 630 (such as a smart phone, wearable computing device, etc.) for displaying or providing audio feedback of an adaptive training plan based on the biometric data. There is multi-direction communication so that the external device 630 and the gym equipment 650 may share data about each other (such as model info, last service info, location, etc.), training information (such as plans, goals, etc.) and metrics of the activity (such as speed, distance, resistance settings, etc.). Thus some embodiments include a software-based application downloadable to the external device 630 that is configured to communicate with the gym equipment 650 and interpret the biometric data and adapt the user's training plan accordingly during a workout session. The software app may gain access to the gym apparatus' controller automatically adjusting output according to the training plan as performance goals are being adapted in real-time. As will be appreciated, the software embodiment provides users with the ability to “retrofit” a gym apparatus 650 for enhanced workouts.

In some embodiments, the biometric feedback is provided by the wearable device 100. As described above, the wearable device 100 may deliver audio and vibration based instructions of pre-recorded and adapted sport training plans or exercise routines to a user whilst simultaneously communicating to gym equipment 650 and adapting the machines' levels of intensity, resistance, inclination, duration, speed and other settings to simulate patterns in physical exercise provides the biometric feedback. For wearable devices that are not only over-the-ear type (for example, wearable glasses, wrist devices, arm devices, etc.) visual instructions may be included that may aid the user in adapting their performance output in real-time.

The wearable device 100 includes sensors to monitor and assess the biometric information of the wearer. In monitoring this data the device 100 actively, in real-time, sends signals to the gym equipment 650 directly or through a third party device (external device 630) such as a smartphone and adapts the gym equipment 650 to increase/decrease exertion levels during different periods, as required by each specific training plan or exercise routine. The sensors may be stand-alone or integrated onto for example control board 180 and may include a heart rate monitor, a GPS, an accelerometer, a barometer, or other measuring sensors. The GPS may be checked to identify locations with compatible gym equipment 650 or track the user's distance and movement (when not on a gym apparatus (for example, when jogging, swimming, or riding)). Wireless signaling may be provided for example by RF input/output components such as a Wi-Fi antenna, an ANT protocol based chip, or a Bluetooth® protocol based antenna. The RF input/output components use a real-time wireless protocols, which enables the wearable device 100 and equipment to be in sync for the duration of the exercise, seamlessly delivering live specific sport and fitness coaching instructions and training routines to help the user achieve fitness goals.

System memory stores training plans, workout data, music, etc. and have the capability to connect with other devices by wireless and wired protocols. A processing unit coordinates the data from the sensors, the system memory, the wireless signaling. The processing unit may be programmed to trigger signaling to the gym equipment 650 to change output based on data from the sensors meeting criteria in the stored workout plans and adaptation schemes. The wearable device 100 may also include audio output (for example, headphones or a speaker) that issues alerts of changed training performance, live coaching guidance 640 and changes in the output from the gym equipment 650.

In an exemplary use, a user enters a gym, with compatible gym equipment 650, and syncs their wearable device 100 to the different equipment they wish to work with or as required by a specific training plan or exercise routine. Syncing of data may be performed using “tap-to-pair”. In this way, the user can do the workout in conjunction with the gym equipment 650 to ensure they achieve their desired goals.

Exercise equipment 650 includes electronic and digital exercise machines, for example treadmills, cycling machines, cycling trainers, rowing machines, step machines, lifting machines and other machines designed for exercising found in both gyms and homes. The equipment may incorporate a visual display or an external device 630 that complements the wearable device 100 guidance and further displays the users data (speed, distance, heart rate, calories, etc.), details of the training plan or exercise routine, a map, and/or video using animated images and/or real footage to make the user feel the user is exercising “on location”. In some embodiments, the gym apparatus 650 being used may not have a digital display but the user may have a software application resident on their mobile computing device (for example, smart phone, tablet, wearable computing device (e.g. smart watch, smart glasses, etc.)) that may include a display to show messages, alerts, etc. and/or a memory to store training plans, music and/or settings.

In operation, the system (or wearable device 100 alone) delivers the sport specific training programs in a dynamic way that adapts to each user according to their current physical condition, current performance and results, and past performances. The system analyzes a combination of processed data, which may include: performance data generated by the sensors on the worn device (for example, heart rate, calories, distance, speed, etc.); stored personal data (for example, weight, height, age, physical condition, etc.); user preferences (for example frequency of voice, intensity levels, etc.); desired goals (for example losing weight, keeping fit, becoming faster, etc.); efficiency levels during performance (for example an increase in heart rate due to low cadence running—not just a heart rate alert); changes in patterns (for example changes in performance based on data generated and compared during different time periods); data generated from previously recorded exercises (not only data generated from the sensors during that exercise, but also data reflecting the results from previous training and compared with the requirements set by the training plans performed); and data generated by other users (data generated by all/part of the population that use our server to store their data). The system may identify data points which may trigger an alert indicating a performance deficiency or physiological danger with other performance indicators to provide actionable feedback to correct that specific deficiency by adjusting other parameters. By using real-time, historic and personal goal adaptations, the workout can be tailored to maximize the user's performance and experience.

The system deploys complete sport specific training programs designed specifically to achieve fitness goals, which may be delivered via voice feedback, vibration based, sound based, and visual based alerts to the user during training. The sport specific training programs and real-time coaching instruct the user how to perform different exercise routines and evolve with the user over time, increasing/decreasing the intensity, changing the exercise routines and adapting the plans to each specific user's physiological past/current performance and predicting the most successful adaptation of the programs to achieve the desired outcomes. Coaching may be provided by sending the user digitized or voice-recorded cues through the device 100's earpiece module 150 (FIG. 1A) in response to a determined need to change the user's current performance output.

The data generated by the sensors during the training programs might be exported to one or more servers for further processing, analysis and program adaptation. The user training data, personal data and preferences, the parameters of the coached session and workout data generated by other users, may be compared to each other, analyzed, and actively adapted to modify the training programs further and/or provide recommendations for subsequent sessions. These adaptions could be for example in the form of increasing or decreasing the duration, distance, effort levels, exercises, stages, etc. to help improve the user's performance and achieve the desired goals. Processes like machine learning, pattern recognition, algorithms and human assessment, may be used for these adaptations that make the training programs evolve and adapt to each user.

From a user perspective, the user may download custom sport specific training programs to the device 100 and then perform said training while receiving voice coaching through the worn device. Training plans, configuration settings, music and additional file content may be transferred securely to and from the device's internal memory using a wired (USB) or any wireless transmission protocol (Bluetooth®, WI-FI etc.). The system may automatically record the user's training results. On completion, the results may be uploaded to the host server. The athlete's performance data may be securely saved to the server and diagnosed in real-time using built-in internet enabled wireless communication protocols (4G, IP over BT etc.). In some embodiments, other users and coaches may receive notification of the user's performance data. The coach may then analyze the data and provide feedback as well as adapt further training programs manually to match the user's required performance indicators (for example, as a service). The data retrievable, in real-time, is analyzed and feedback is provided instantly to the athlete. In this scenario, a coach may monitor and coach several athletes and provide feedback and support instantly. The online portal may include a feature allowing coaches to be reviewed and rated based on their interactions thus enabling additional users to see and connect with the most appropriate coaches and download the most suited Sport Specific Training Programs to achieve their goals.

In some embodiments, the system also provides music to increase motivation during training. The music may be stored in the device 100 or streamed through another device into the device 100. The music management can be operated manually at the device 100 or according to predetermined settings that allow its automatic deployment based on different parameters like user preferences, intensity levels, program duration, heart rate, speed, distance, achievements, exercises, etc.

Using a global navigation system (such as onboard GPS technology), the system can provide location based services, feedback, navigation guidance and route recommendations. For example, direct the user to previous routes, popular routes, routes shared by other users, routes to meet other users, routes based on difficulty levels, location alerts, and locations of gym equipment 650 (FIG. 6) compatible with system embodiments described above, etc.

In some embodiments, the device 100 may incorporate cryptographic features which, along with the wireless protocols within the device, enable it to act as a smart key. A user may upload their digital key to the device and when in proximity to the matching lock may wirelessly exchange the secure lock/key information. In this scenario, the user could then go for a run and leave their house key at home reducing the amount of items the user would need to carry during exercise.

The wearable device 100 may be a self-contained coaching device, which may work entirely by itself to monitor biometrics, using the athlete's past and current performance statistics and recorded performance data from other athletes to actively adapt the file parameters to provide real-time feedback to a user. Some embodiments include waterproofing to prevent moisture from ambient water while swimming or the athlete's sweat from penetrating the circuitry contained internally. The wearable device 100 may operate completely independently using its integrated microchip, memory and integrated sensors, or it can also operate connected to other devices wirelessly, like for example the gym equipment 650 (FIG. 6), smart phones, watches, tracking devices, bike sensors, power meters, etc. Device functions are accessible using menu systems and controls (for example, control switch 140 of FIG. 1A). As will be appreciated, embodiments integrate a host of functions including for example heart rate monitoring, accelerometer measurements, gyroscopic movement sensing, barometric measurements, timing measurements, along with auditory means to transmit real-time personalized coaching during a training session.

Those of skill in the art would appreciate that various components and blocks may be arranged differently (e.g., arranged in a different order, or partitioned in a different way) all without departing from the scope of the subject technology.

The previous description is provided to enable any person skilled in the art to practice the various aspects described herein. The previous description provides various examples of the subject technology, and the subject technology is not limited to these examples. For example, while the device 100 was described in the context of an over-the-ear headset, other types of wearable devices may be used such as wearable smart glasses, wearable smart jewelry, wearable smart wrist or arm devices, etc. which may incorporate the biometric feedback functions and live coaching/adaptive training feedback without departing from the scope of the invention. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the invention.

Terms such as “top,” “bottom,” “front,” “rear,” “above,” “below” and the like as used in this disclosure should be understood as referring to an arbitrary frame of reference, rather than to the ordinary gravitational frame of reference. Thus, a top surface, a bottom surface, a front surface, and a rear surface may extend upwardly, downwardly, diagonally, or horizontally in a gravitational frame of reference. Similarly, an item disposed above another item may be located above or below the other item along a vertical, horizontal or diagonal direction; and an item disposed below another item may be located below or above the other item along a vertical, horizontal or diagonal direction.

A phrase such as an “aspect” does not imply that such aspect is essential to the subject technology or that such aspect applies to all configurations of the subject technology. A disclosure relating to an aspect may apply to all configurations, or one or more configurations. An aspect may provide one or more examples. A phrase such as an aspect may refer to one or more aspects and vice versa. A phrase such as an “embodiment” does not imply that such embodiment is essential to the subject technology or that such embodiment applies to all configurations of the subject technology. A disclosure relating to an embodiment may apply to all embodiments, or one or more embodiments. An embodiment may provide one or more examples. A phrase such an embodiment may refer to one or more embodiments and vice versa. A phrase such as a “configuration” does not imply that such configuration is essential to the subject technology or that such configuration applies to all configurations of the subject technology. A disclosure relating to a configuration may apply to all configurations, or one or more configurations. A configuration may provide one or more examples. A phrase such a configuration may refer to one or more configurations and vice versa.

The word “exemplary” is used herein to mean “serving as an example or illustration.” Any aspect or design described herein as “exemplary” is not necessarily to be construed as preferred or advantageous over other aspects or designs.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.” Furthermore, to the extent that the term “include,” “have,” or the like is used in the description or the claims, such term is intended to be inclusive in a manner similar to the term “comprise” as “comprise” is interpreted when employed as a transitional word in a claim.

What is claimed is:

1. A system for improving sports performance, comprising:
a remote computer server;
data storage in the remote computer server storing a pre-defined set of training goals for a user and past recorded training data from past training sessions performed by the user; and
an electronic gym apparatus, including:
a resistance or speed based exercise function,
a wireless transceiver, and
a processor is configured to:
detect an amount of exercise output performed by the user during a live training session using the gym apparatus,
compare the amount of exercise output performed by the user during the live training session using the gym apparatus to goals in the pre-defined set of training goals and to the past recorded training data from past training sessions performed by the user,
analyze the amount of exercise output performed by the user during the live training session using the gym apparatus and the past recorded training data from past training sessions performed by the user for changes in performance, and
adjust the electronic gym apparatus to increase or decrease exercise resistance or speed based on detecting changes in performance by the user.

2. The system of claim 1, further comprising a mobile electronic device wirelessly connectable to the electronic gym apparatus, wherein the electronic gym apparatus is configured to detect the presence of the mobile electronic device.

3. The system of claim 2, wherein in response to detecting the presence of the mobile electronic device, the remote computer server transmits to the electronic gym apparatus the pre-defined set of training goals for the user.

4. The system of claim 2, further comprising a software application run on the mobile electronic device, the software application configured to display current performance training of the user during the live training session.

5. The system of claim 2, wherein the electronic gym apparatus is further configured to detect a tap to pair action from the mobile electronic device.

7. The system of claim 1, wherein the electronic gym apparatus is further configured to adjust the training performance goals based on other users' recorded performances stored in the remote computer server.

8. The system of claim 1, further comprising a smart wearable device including a GPS and an alert configured to detect a location of the electronic gym apparatus and provide the user with the detected location.

9. The system of claim 1, further comprising a smart wearable device in communication with the electronic gym apparatus, the smart wearable device configured to provide audible or visual live coaching cues during the live training session in response to the detected changes in performance during the live training session.

10. The system of claim 9, wherein the smart wearable device issues an alert to the user in response to a change in the electronic gym apparatus' output.
